(19) United States
(12) Patent Application Publication
(10) Pub. No.: US 2009/0119762 A1
(43) Pub. Date: May 7, 2009

(54) WLAN Access Integration with Physical Access Control System

(75) Inventors: Allan Thomson, Pleasanton, CA (US); Matthew Glenn, San Francisco, CA (US); Prabandham Madan Gopal, Los Altos, CA (US); Vinod Dashora, Fremont, CA (US); Neeraj Purandare, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 12/043,701

(22) Filed: Mar. 6, 2008

Related U.S. Application Data
(60) Provisional application No. 60/985,968, filed on Nov. 6, 2007.

(51) Int. Cl. H04L 9/32

(52) U.S. Cl. 726/7

(57) ABSTRACT

A network access system. In particular implementations, a method includes monitoring, responsive to a network access request of a client, an authentication session between an authentication server and the client, and determining user credential information associated with a user of the client based on one or more messages of the authentication session. The method also includes accessing, using the user credential information, physical entry information indicating a physical location of the user relative to a defined perimeter, and conditionally allowing the client access to a network based on the physical entry information and a successful authentication of the client.

### CROSS-REFERENCE TO RELATED APPLICATION

The present application claims priority to U.S. Provisional Application Ser. No. 60/985,968, filed Nov. 6, 2007 entitled “In-Building WLAN Access Integration with Physical Access Station,” which is incorporated by reference herein for all purposes.

### TECHNICAL FIELD

The present disclosure relates generally to wireless and wired networks and, more particularly, to network access control systems.

### BACKGROUND

Market adoption of wireless LAN (WLAN) technology has exploded, as users from a wide range of backgrounds and vertical industries have brought this technology into their homes, offices, and increasingly into the public air space. This inflection point has highlighted not only the limitations of earlier-generation systems, but also the changing role that WLAN technology now plays in people's work and lifestyles across the globe. Indeed, WLANs are rapidly changing from convenience networks to business-critical networks. Increasingly users are depending on WLANs to improve the timeliness and productivity of their communications and applications, and in doing so, require greater visibility, security, management, and performance from their networks.

In recent years surveillance of public and private areas for purposes of enhanced security has increased considerably. Surveillance may take many forms such as video, use of security badges, etc. Users typically access WLAN networks from inside secured areas such as buildings. However, WLAN networks typically radiate beyond the physical boundaries of the buildings that house wireless access points of the WLAN networks. This creates a problem for customer environments where it is undesirable to have anyone outside of a building or secured area gain access to the WLAN network even if those accessing the network have sufficient and secure credentials to access the network.

### DESCRIPTION OF THE DRAWINGS

FIG. 1A illustrates example components in a wireless local area network (WLAN) system.

FIG. 1B illustrates an example hierarchical wireless network including a central controller.

FIG. 1C illustrates an example hardware system, which may be used to implement a central controller.

FIG. 2 illustrates an example hardware system, which may be used to implement a WLAN management server.

FIG. 3 illustrates an example process flow implemented at a central controller.

FIG. 4 illustrates an example process flow implemented at a location server.

FIG. 5 illustrates an example of a secured area on a single floor.

FIG. 6 illustrates an example of multiple secured areas on a single floor.

FIG. 7 illustrates an example of a secure first floor in a single building having multiple floors.

FIG. 8 illustrates another example of a secure first floor in a single building having multiple floors.

FIG. 9 illustrates example buildings, one of which has all floors secured.

FIG. 10 illustrates an example scenario where a user approaches a secured area.

FIG. 11 illustrates an example scenario where a user enters a secured area using a security badge.

FIG. 12 illustrates an example scenario where a wireless client of a user is associated with a wireless access point within a secured area.

FIG. 13 illustrates an example scenario where a user exits a secured area using an security badge.

FIG. 14 illustrates an example scenario where a user has one or more wireless clients physically with the user and associated with a wireless access point in a secured area as the user approaches the secured area.

FIG. 15 illustrates an example scenario where a user has physically entered a secured area using a security badge.

FIG. 16 illustrates an example scenario where one or more wireless clients of a user are associated with a wireless access point within a secured area.

### DESCRIPTION OF EXAMPLE EMBODIMENTS

### A. Overview

Particular implementations facilitate network security in a wireless network. According to particular implementations, the present invention integrates building access functionality directed to monitoring or controlling physical access to a secured area or building with authentication functionality directed to controlling logical access to a network infrastructure. When the WLAN infrastructure (location server in combination with the controllers) detects a WLAN client attempting to authenticate to the WLAN network, part of the authentication process combines the physical access knowledge (where the user is identified based on the sequence of badge entry notifications received) with their authentication credentials (e.g., 802.1x credentials or other suitable credentials) coming from the client. Given this combination, the network infrastructure allows or denies access to the WLAN for that user's set of devices based on area they entered, and the WLAN they are trying to access. Some implementations of the invention can be configured to ensure that a user is within a secured area before permitting WLAN access to a wireless client associated with the user. This may be achieved by the WLAN network granting access to the WLAN after receiving a successful authentication indication from the authentication server and after receiving an indication that the user has physically entered the secured area.

In one implementation, the location server may use, or operate in connection with, a physical access firewall that controls and/or monitors access to a secured area perimeter (such as a building) to detect and record entry and exit times of users. The physical access firewall may comprise a building access control system that controls access to ingress and egress points (including, for example, but not limited to doors and hallways) based on presentation of one or more physical credentials, such as a badge, a password, biometric attributes (e.g., finger or hand print analysis, voice analysis, face recognition, retinal scans, etc.). In one implementation, the physical access firewall provides management functionality to enable a user to configure, monitor, and report on the physical firewall tools.

### B. Example Wireless Network System Architecture

B.1. Network Topology

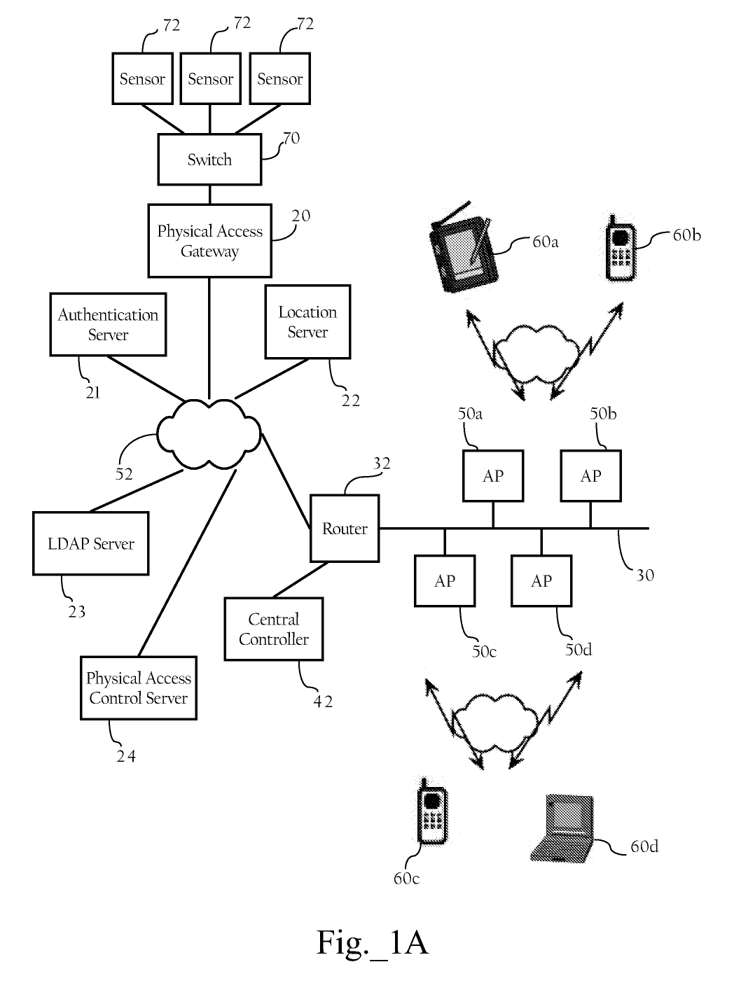

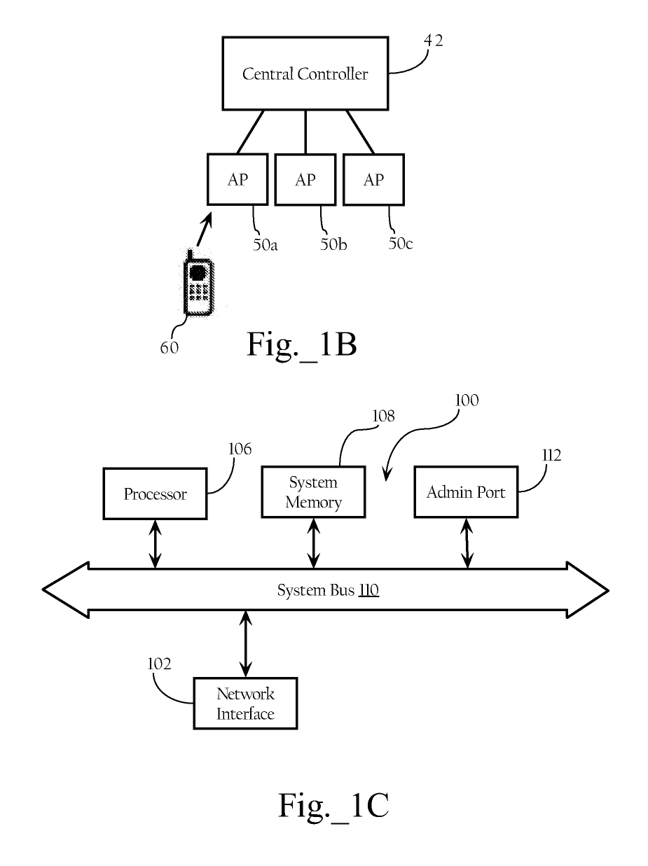

FIG. 1A illustrates example components in a wireless local area network (WLAN) system. In a specific embodiment of the present invention, the system includes a physical access gateway 20, an Authentication Authorization and Account (AAA) server 21, a location server 22, a lightweight directory access protocol (LDAP) server 23, and a central controller 42, a local area network (LAN) 30, a router 32, and wireless access points 50a, 50b, 50c, and 50d. In one implementation, the system also includes a physical access control server 24. In one implementation, physical access control server 24 may provide notification on physical access granted or denied for a given user based on credentials presented at any sensor front-ended by physical access gateway 20 or other access control gateway. In one implementation, the system also includes a switch 70 and sensors 72. As FIG. 1A shows, the sensors 72 connect over the network to switch 70, which connects to physical access gateway 20. This implementation may involve, for example, IP-based badge readers. In an alternative implementation, sensors 70 may connect to physical access gateway 20, which connect to switch 70. This alternative implementation may involve, for example, sensors that are not connected over an IP network. As described in more detail below, in one implementation, sensors 72 may operate in connection with a physical access control system, such as a security badge access system, and are attached to doorways (or other points of ingress or egress) around a secured area, such as a building. LAN 30 is implemented by a switch (or an array of switches) and/or other network devices, such as a bridge. In particular implementations, these components are functional blocks representing processes implemented in hardware, software, or a combination thereof. For example, AAA server 21 may be a software module hosted on a computing platform such as building access management server 20, central controller 42, etc. In one implementation, AAA server 21 provides authentication services for wireless clients. In one implementation, the authentication mechanisms supported may be any suitable authentication protocol such as 802.1X Extensible Authentication Protocol (EAP), which is typically used for username authentication. A LDAP server 23, in one implementation, maintains information associated with individual users, such as user names, physical access credential information, network access credential information, identifiers for devices associated with respective users, and the like. Other nodes, such as physical access gateway 20 may use the LDAP server 23 to resolve user names or identifiers in response to sensors 72 that report detection of a given physical credential, such as an access badge. Physical access gateway 20 hosts logic and other functionality that implements a physical access monitoring and/or control system, by which users movement into and out of a physical region are controlled and tracked.

As FIG. 1A illustrates, these network elements are connected to a network 52. Network 52, in one implementation, generally refers to a computer network, such as a LAN, a WAN, etc., that includes one or more intermediate network devices (e.g., routers, switches, etc.), which allow for the transmission of messages between WLAN management server 20 and wireless clients via wireless access points 50. Also, the WLAN may include WiFi, WiMax, BlueTooth, or other suitable standards). Of course, network 52 can include a variety of network segments, transmission technologies and components, such as terrestrial WAN links, satellite links, optical fiber links, and cellular links. Network 52 could also be a campus LAN. LAN 30 may be a LAN, LAN segments implemented by an Ethernet switch (not shown), or an array of switches having multiple ports to which wireless access points 50 are connected. The wireless access points 50 are typically connected to switch ports via Ethernet links; however, other link layer connection protocols or communication means can be employed. FIG. 1A illustrates one possible network environment in which the invention may operate; however, other implementations are possible. For example, although WLAN management server 20 is illustrated as being on a different LAN or LAN segment, it may be co-located with wireless access points 50.

The wireless access points 50 wirelessly communicate with remote wireless clients 60a, 60b, 60c, and 60d. In one implementation, each wireless client 60 stores access credentials that provide permission to access the WLAN network. In particular implementations, wireless client 60 may be a mobile device, such as a notebook computer, mobile phone, and the like. In one implementation, the wireless access points 50 implement the wireless network protocol specified in the IEEE 802.11 WLAN specification; of course, other wireless network protocols other network hardware/physical layer may be used. The wireless access points 50 may be autonomous or so-called “fat” wireless access points or light-weight wireless access points operating in connection with a wireless switch (see FIG. 1B). In addition, the network infrastructure may also include a Wireless LAN Solution Engine (WLSE) offered by Cisco Systems, Inc. of San Jose, Calif. or another wireless network management system. In some implementations, the network infrastructure may also include one or more Wireless Control System (WCS) nodes operative to manage one or more wireless switches and access points.

In one implementation, central controller 42 provides aggregation for Light-Weight Access Point Protocol (LWAPP)-based wireless access points or Control and Provisioning of Wireless Access Points (CAPWAP) protocol-based wireless access points and performs the basic functions to coordinate the firewall functionality disclosed herein. In one implementation, an LWAPP wireless access point provides data access and location tracking while the wireless clients are within the perimeter of the network. Location server 22 may provide the decision making for the physical firewall system and also provides on-going location tracking once a wireless client has gained access to the network.

In one implementation, the WLAN system discussed above operates in connection with a physical access control system, such as a security badge access system, which includes one or more entry/exit units and a set of sensors 72 attached to doorways (or other points of ingress or egress) around a secured area, such as a building. In particular implementations, the sensors 72 are managed and controlled by a system such as physical access gateway 20, which communicates with location server 22, which takes sensor feeds and security badge data to determine when a user physically enters or exits the secured area or building. In one implementation, upon receiving a sensor trigger from a sensor 72 at a doorway, the security badge access system looks up the associated user credentials for the security badge. The security badge access system then passes the doorway identifier, security badge ID, and user credentials to the appropriate nodes of the WLAN infrastructure (e.g., location server 22, etc.), or stores them in a network addressable data store accessible to the nodes of the WLAN infrastructure. The doorway identifier helps the WLAN infrastructure identify which doorway of the secured area the user has entered or exited. The physical environment description may be synchronized across the security badge security system and the WLAN infrastructure decision point (i.e., central controller 42 or a location server 22).

B.2. Central Controller

FIG. 1B illustrates an example hierarchical wireless network including a central controller 42 according to one implementation of the present invention. In one implementation, the central controller 42 may be implemented as a wireless domain server (WDS) or, alternatively, as a wireless switch. If the central controller 42 is implemented with a WDS, the central controller 42 is operative to communicate with autonomous or so-called “fat” wireless access points. If the central controller 42 is implemented as a wireless switch, the central controller 42 is operative to communicate with light-weight wireless access points and process wireless protocol and network management information. As FIG. 1B illustrates, a central controller 42 may be directly connected to one or more access points 50. Alternatively, a central controller 42 may be operably connected to one or more access points over a switched and/or routed network environment, as FIG. 1A illustrates.

FIG. 1C illustrates an example hardware system 100, which may be used to implement a controller 42. As FIG. 1C shows, in one implementation, the central controller 42 includes a network interface 102. Controller 42, in one implementation, further comprises a processor 106, a memory 108, one or more software modules stored in memory 108, including instructions for performing the functions described herein, and a system bus 110 operably connecting these components. The central control elements may optionally include an administrative port 112 allowing for administrative access for such purposes as configuration and diagnostic access.

### C. Network Access Based on Building Access Information

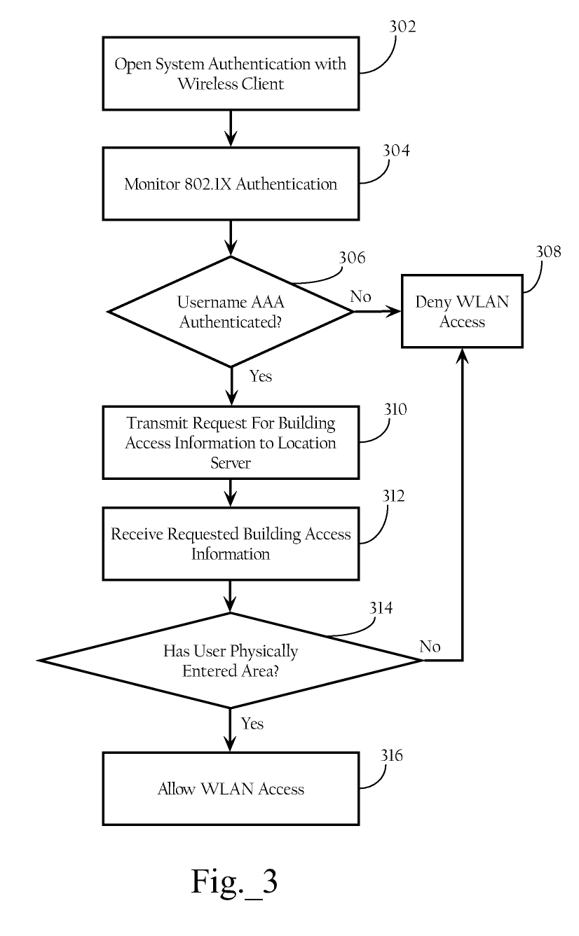

FIG. 3 illustrates an example process flow implemented at the central controller 42. As FIG. 3 shows, central controller 42, in connection with an access point, establishes a wireless connection with a wireless client 60 using for example open systems authentication (302). The central controller 42 then monitors the authentication session between the wireless client 60 and the authentication server 21 (304), during which the user of the wireless client 60 (in one implementation) is challenged for user credentials, such as a user name and password. In one implementation, since the central controller 42 is in the communications path between the authentication server 21 and the wireless client 60, it can monitor the authentication session by accessing the messages transmitted between the hosts. Specifically, in one embodiment, the central controller 42 proxies the messages for the wireless client 60 and the communication is from the central controller 42 to the AAA server 21. The the central controller 42 then sends the result back to the wireless client 60. In some protocols, if the wireless client 60 successfully authenticates, the authentication server 21 transmits an AUTH-SUCCESS or equivalent message. When the controller 42 detects a user credential (e.g., the client's 802.1X username), either at the start or end of a 4-way handshake with the authentication server 21, the controller 21 can send a Physical Firewall In/Out Request message to the Location Server 22 requesting an Allow or Deny decision (310). If wireless client 60 is not authenticated 306), central controller 42 denies access to the network (308). However, if the wireless client is authenticated but outside the physical secured area (as determined by the location server 22) (314), the central controller 42 also denies WLAN access to the wireless client 60 by sending an authentication-failure message to the wireless client 60. If the user has physically entered the secured area, central controller 42 allows access to the network (316). In one implementation, denial may be similar to when an 802.1X port is blocked (e.g., no data traffic will be allowed to flow). In one implementation, central controller 42 may still allow wireless client 60 to join the network if authentication is successful while the in/out determination from location server 22 is still in progress. In one implementation, when the 802.1X authentication completes before the in/out determination, the 802.1X AUTH response may be held at the central controller 42 until the in/out determination is made.

In one implementation, if location server 22 cannot determine whether the wireless client is in or out of the secured area, location server 22 may return an “unknown” status to central controller 42, in which case central controller 42 may delay its decision whether to allow or deny access to the network or may apply another policy. In one implementation, location server 22 may retry a determination after a retry timeout, which may be configurable set to a default time (e.g., 5 seconds). After a pre-configured number of retry attempts, central controller 42 considers a given user to be out of the secured area and de-authenticates the wireless client 60 of the user. In one implementation, the determination of the location of the user may occur in parallel with the authentication process described above.

C.1. Processing Sensor Notification Messages

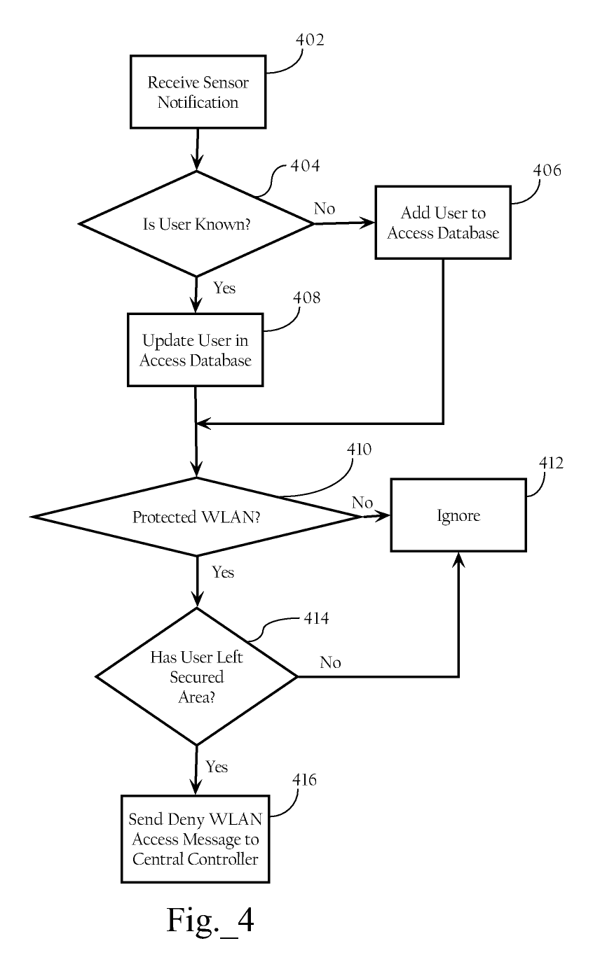

FIG. 4 illustrates an example process flow implemented at the location server 22, which processes sensor notification messages identifying users to determine whether the users have entered or left a given area. In one implementation, whenever a user enters or exits a secured area, a sensor is triggered, causing physical access gateway 20 to transmit sensor notifications to the location server 22. In one implementation, the sensor notification may include the identifier of the access sensor and the user's 802.1X username. As FIG. 4 shows, when location server 22 receives sensor notifications from the physical area access system (402), the location server 22 determines if the user is known (404). If not, location server 22 adds the user to an access database (406). If the location of the user is known, location server 22 updates information for the user in the access database (408). By updating the access database, location server 22 may accurately and promptly respond to requests from central controller 42 for building access information (e.g., in/out indications) also referred to as physical entry information, as it indicates a physical location of a given user relative to entry and access points in the defined perimeter of the secured area.

Location server 22 then determines if the wireless client 60 of the user is on a protected WLAN (410). If not, location server 22 ignores the sensor notification (412). If the wireless client 60 is on a protected WLAN, location server 22 determines if the user has left the secured area (414). If not, location server 22 ignores the sensor notification (412). If the user has left the secured area, location server 22 sends a deny WLAN access message to central controller 42, causing it to de-authenticate (or otherwise terminate the connection with) the wireless client 60 of the user (416).

C.2. Firewall

In particular implementations, the WLAN system may have an option whether a physical firewall is enabled, and the physical firewall may be configurable so that central controller 42 can apply a physical firewall policy to the WLAN. In one implementation, if a given WLAN supports multiple authentication mechanisms, enabling a physical firewall on that WLAN enables the physical firewall across all authentication methods.

In one implementation, the physical firewall may be initiated when a wireless client is attempting to access the network, and the network detects if the wireless client may require full AAA authentication. This applies to a wireless client accessing the network for the first time or after roaming across mobility domains where the wireless client's keys are not cached by the network.

The physical firewall may be deployed in parts of a customer environment where security is desired. In one implementation, any capabilities defined to manage the firewall system may assume that not all network elements are part of the firewall. For example, if an audit security procedure exists to analyze the security of a firewall, the procedure would not assume it has to audit all other controllers and wireless access points in the network.

C.2.a Firewall Configuration

In one implementation, once a customer has physically deployed the network, a firewall configuration phase occurs. In one implementation, the following configuration actions may be performed before the physical firewall becomes active.

C.2.a.i Physical Environment Setup

In one implementation, the customer may define various aspects of the physical space that a network is deployed in. For example, the customer may define the campus, buildings, floor plans and their dimensions. The customer may also define entry/exit points in the floor plan and identify their IDs. The customer may also define multiple sensors per doorway. The customer may add to maps all of the wireless access points discovered when adding controllers to the network. In one implementation, the customer may define one or more perimeters on each floor plan and mark where sensors reside on a particular perimeter. In one implementation, one or more perimeters on the same floor may be contained within an outer perimeter. In one implementation, the customer may define perimeters having various shapes such as polygons and rectangles.

C.2.a.ii Location Server Configuration

In one implementation, once the maps, controllers, perimeters, and sensors have been setup, the customer may then configure location servers that will perform in/out determinations. In one implementation, the customer may configure a list of location servers that each controller should use for making in/out determinations. This configuration allows create and push templates to controllers as a batch/group operation. In one implementation, for each location server, the network designs and the set of controllers that it will monitor/manage may be pushed using location synchronization. In one implementation, for each location server, the perimeters and set of Access Sensors on that perimeter may be pushed using location synchronization.

C.2.b. Firewall Monitoring

In particular implementations, the WLAN infrastructure may provide monitoring capabilities that are fully supported in the physical firewall network. The following are example physical firewall specific monitoring features. In one implementation, the WLAN infrastructure may provide the status of the access sensor network (e.g., up/down status of the sensors) for firewall monitoring.

In one implementation, the WLAN infrastructure may monitor firewall performance, including when particular wireless clients are permitted or denied access per perimeter, and listing the wireless clients, their locations, and timestamps for all decisions per wireless client. The WLAN infrastructure also may monitor performance of decision making, which may include throughput and performance of links between central controller 42 and location server 22, statistics of packets/bytes going to each location server, ping functions, and round-trip times for each link to location server 22.

In one implementation, the WLAN infrastructure may monitor firewall faults. For example, when a location server 22 goes down or cannot be reached, the WLAN infrastructure may generate a critical alarm that may be correlated to any perimeters for which the location server was responsible. In one implementation, there may be a trap defined in the controller whenever it fails to communicate to a location server for an in/out determination regarding a user or wireless client. To ensure that the network is not overloaded, the trap may be generated the first time a connection is lost and subsequently on a preconfigured period basis.

C.2.c. Firewall Reporting

In one implementation, the WLAN infrastructure may generate various reports. For example, a report may indicate when wireless clients have been permitted or denied per area/perimeter historically. Such a report may include counts and lists of wireless client details including which perimeters were involved. A report may indicate historical in/out determinations per location server, including counts and lists of wireless client details, and decision loading per location server. A report may indicate downtime and uptime of any critical firewall components.

C.2.d. Firewall Software Preferences

This section describes various preferences on the central controller 42 software architecture to implement a physical firewall. In one implementation, the central controller architecture for physical firewall functions may include initiators. In one implementation, initiators detect when a firewall decision may be made and trigger physical firewall functions. In one implementation, an initiator may be based on a wireless client association. For example, when a wireless client is accessing the network for the first time the physical firewall will be activated. In one implementation, an initiator may be based on wireless client re-association across mobility domains (e.g., when a wireless client has roamed across mobility domain boundaries).

In one implementation, the central controller architecture may include physical firewall functions, which accepts requests from initiators. In one implementation, the physical firewall functions may be responsible for wireless client reporting and decision making (e.g., in/out determinations).

C.2.e. Firewall Policy Management

When a wireless client is accessing the network for the first time, central controller 42 may launch a physical firewall functions associated with a given wireless client. In one implementation, the physical firewall functions, which may facilitate in the location servers 22 in/out determinations, may run in parallel with wireless client's layer2/layer3 authentication processes.

In particular implementations, if the wireless client completes its layer2/layer3 authentication process before the physical firewall functions are complete, central controller 42 may policies to determine whether the wireless client is allowed to pass data traffic.

C.2.e.i. Strict In/Out Determination

In one implementation, in/out determinations may occur as the wireless client goes through layer-2 authentication (e.g., dot1x, open, etc.), mobility handling, and layer-3 authentication (e.g., DHCP, IPSec, etc.). If the wireless client succeeds in these authentication processes before the in/out determination, central controller 42 may keep the wireless client associated but drop all data traffic sent to or received from the wireless client until the wireless client succeeds in the in/out determination process. In one implementation, the following are types of traffic which are allowed to pass through central controller 42 before finishing the in/out determination: Address Resolution Protocol (ARP) traffic, Dynamic Host Configuration Protocol (DHCP) traffic, and Domain Name Service (DNS) traffic.

C.2.e.ii. Loose In/Out Determination

In one implementation, the in/out determination process occurs while the wireless client goes through a layer-2 authentication process (e.g., dot1x, open, Wired Equivalency Privacy (WEP), etc.), mobility handling, and a layer-3 authentication process (e.g., DHCP, IP Security (IPSec), Etc.). If the wireless client succeeds in its authentication processes before the in/out determination process, central controller 42 may allow the wireless client to send and receive data packets. If the in/out determination concludes that the wireless client is out of the secured area, central controller 42 may de-authenticate the wireless client.

C.2.e.iii. In/Out Determination Notification

In one implementation, the in/out determination occurs as the wireless client goes through a layer-2 authentication process (dot1x, open, wep), mobility handling, and a layer-3 authentication process (e.g. DHCP, IPSec). If the wireless client succeeds these authentication processes before the in/out determination, central controller 42 may allow the wireless client to send and receive data packets. If in/out determination concludes that the wireless client is outside the secured area, central controller 42 will not de-authenticate the wireless client but will send SNMP trap to notify that the wireless client has failed authentication.

C.3. In/Out Policies

As describe in more detail below, in particular implementations, central controller 42 may apply in/out policies to determine whether to allow network access to a particular wireless client of a particular user.

In one implementation, a global in/out policy may apply. For example, whenever the user enters a secured perimeter, wireless clients on which the user identity authenticates may be allowed on the network regardless of physical location within the secure perimeter. Whenever a user exits the secured perimeter, wireless clients on which the user identity authenticates will be denied access to the network regardless of physical location outside the secure perimeter.

In one implementation, a specific-perimeter in/out policy may apply. For example, whenever a user enters the secured perimeter, devices on which the user identity authenticates will be allowed on the network if the wireless clients are determined to be within a configurable range of the perimeter.

In one implementation, each wireless client allowed on the network may be given an access lease based on a configurable time period. In one implementation, once the lease period expires, the device will be de-authenticated from the network.

In one implementation, when a user exits the secured area, the user may or may not choose to badge out of the secured area. In one implementation, if the user does badge out of the secured area, wireless clients outside a configurable range of the secured area may be de-authenticated.

In one implementation, other wireless clients belonging to the user in other areas or other secured areas may be unaffected by either entry or exit action on a specific secured area. In one implementation, location server 22 determines the proximity of wireless clients to a given user to ensure that multiple devices of the given user in different secured areas are not affected by the user entering or leaving a given secured area.

### D. Physical Deployment

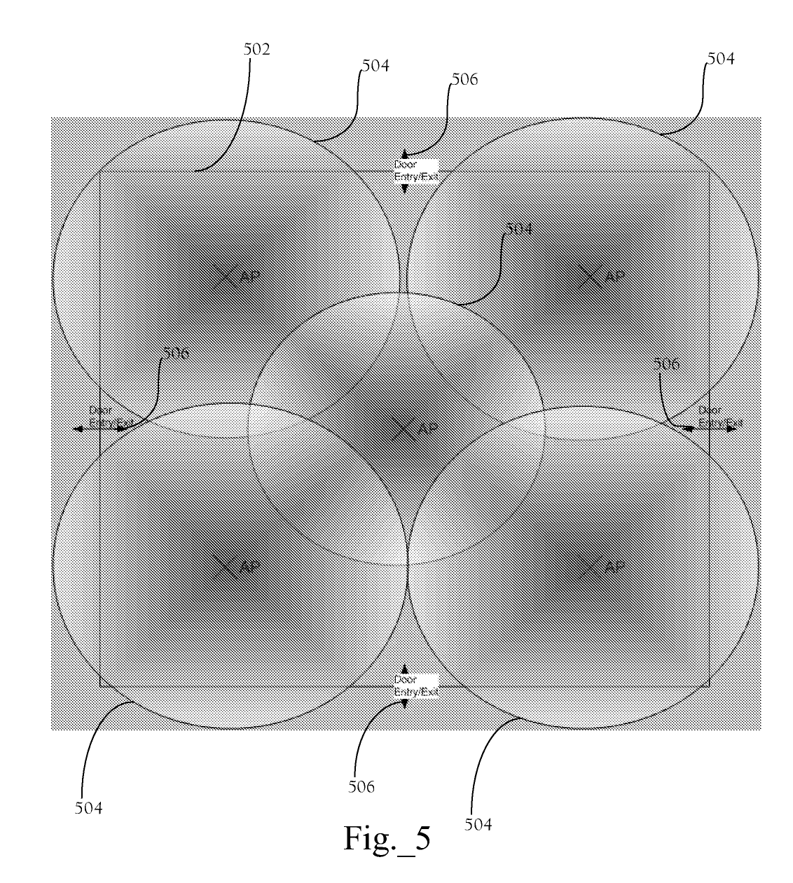

FIG. 5 illustrates an example secured area 502 on a single floor. As FIG. 5 shows, the secured area may be defined by a physical perimeter (e.g., the walls of a building, the walls of a room, etc.) having radio frequency (RF) coverage areas 504 which typically extend beyond the physical perimeter. As indicated above, in one implementation, secured areas include entry/exit units 506 (e.g., physical entry/exit swipe machines) and sensors deployed on doors on the perimeter of each secured area 502. In particular implementations, a given user may swipe or scan a security badge or other user identifying device at an entry/exit units machines upon entering or exiting a secured area.

In one implementation, in this example, central controller 42 may apply a global in/out policy, as described above, to control network access. For example, if a user enters secured area 506, all wireless clients of the user within the secured area 502 are allowed access to the network. If the user exits secured area 506, all wireless clients of the user in the secured area 502 will be denied access to the network.

In one implementation, central controller 42 may apply a specific-perimeter in/out policy to control network access. For example, if a user enters the secured area 502, all wireless clients of the user within the perimeter is allowed access on the network but all other wireless clients of the user outside of the configurable range of the secured area 502 are denied access to the network. If the user exits the secured area 502, all wireless clients outside the configurable range of the secured area 506 will be denied access to the network.

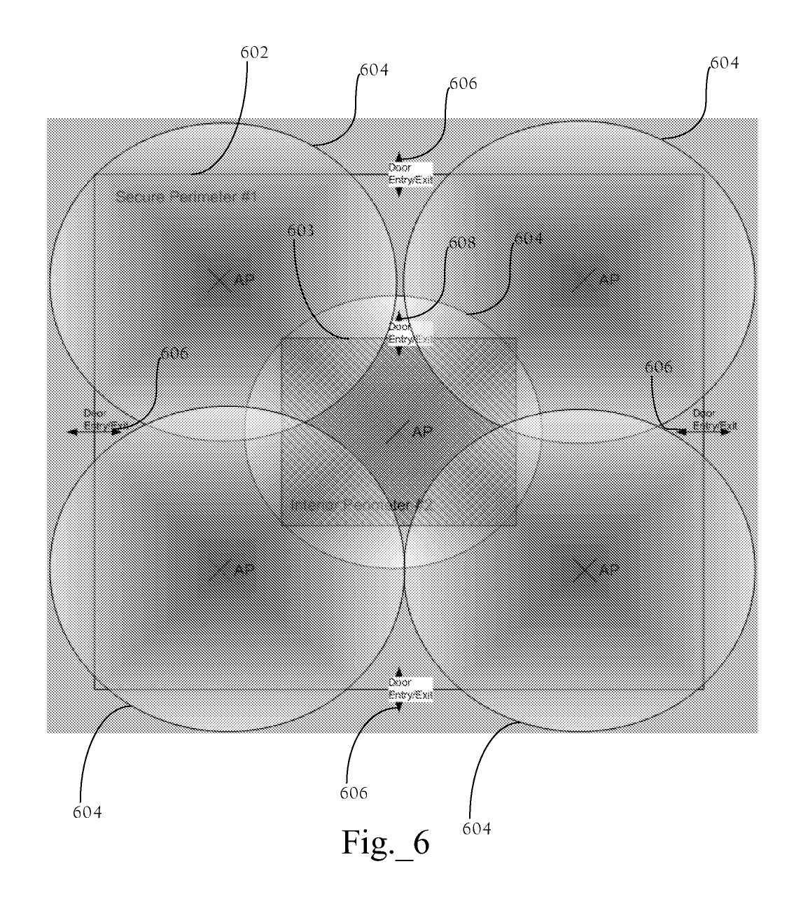

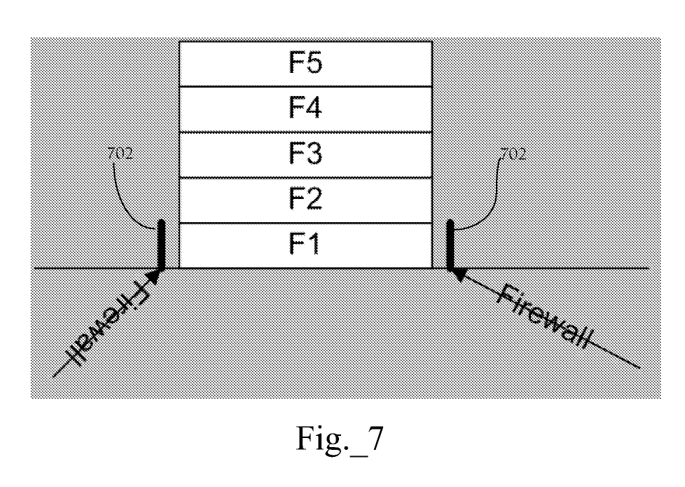

FIG. 6 illustrates an example multiple defined secured areas 602 and 603 on a single floor. As FIG. 6 shows, an inner secured area 603 is positioned within an outer secured area 602. In one implementation, the secured areas have RF coverage areas 604, which typically extend beyond the physical perimeter of the secured areas 602 and 603. In one implementation, entry/exit units 606 have sensors which are deployed at doors to secured area 602 and which are associated with secured area 602. Entry/exit unit 608 has sensors which are deployed at a door to secured area 603 and which are associated with secured area 603. In one implementation, secured areas 602 and 603 may be administratively separate (e.g., separate WLAN networks) but may have overlapping RF coverage areas as shown.

In one implementation, in this example, central controller 42 may apply a global in/out policy to control network access. For example, if a user enters the outer or inner secured area 602, all wireless clients of the user within the respective secured areas 602 or 603 are allowed access on the network. If the user exits either of secured areas 602 or 603, all wireless clients within either respective secure area 602 or 603 will be denied access to the network.

In one implementation, central controller 42 may apply a specific-perimeter in/out policy to control network access. For example, if the user enters the inner secured area 603, all wireless clients of the user within the inner area 603 are allowed access on the network. All other devices belonging to that user outside of a configurable range of the inner area 602 are denied access to the network. If the user exits either secured area 602 or 603, all wireless clients of the user outside the configurable range of the respective secured areas 602 or 603 are denied access to the network.

In one implementation the same WLAN may be used for both secured areas 602 and 603, each secured area having different virtual LANS (VLANS). In one implementation, VLAN changes may be issued as users enter the inner secured area 602. In particular implementations, a location node such a location server 22 may keep track of the specific secured area the user is in.

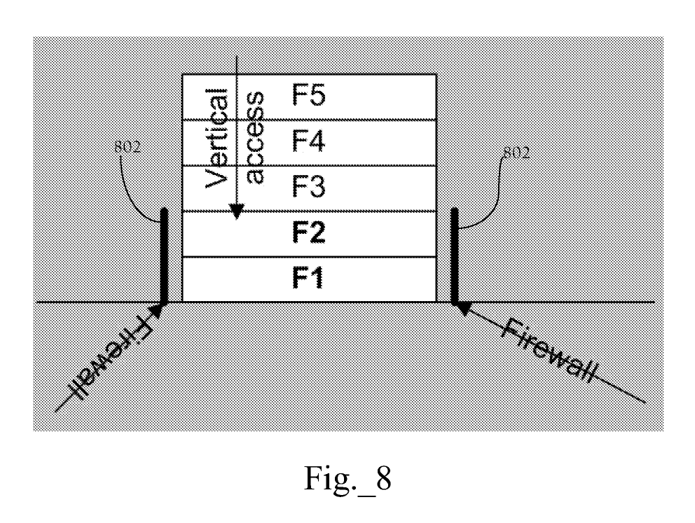

FIG. 7 illustrates an example of secure first floor in a single building having multiple floors. As FIG. 7 shows, the building includes floors F1-F5 with a firewall 702 securing the first floor F1 of the building from intruders attempting to gain access from the street level. In particular implementations, wireless access points are deployed on all floors and the entry/exit doors are on the first floor F1. Wireless clients in other buildings physically close enough will typically not be able to gain access to the internal network.

In one implementation, in this example, central controller 42 may apply a global in/out policy to control network access. For example, if a user enters the secured first floor F1, all wireless clients within the building (and all floors) are allowed access on the network. If the user exits the secured first floor F1, all wireless clients in the entire building will not be able to access the network.

In one implementation, central controller 42 may apply a specific-perimeter in/out policy to control network access. In one implementation, if a user enters the secured first floor F1, all wireless clients of the user within the first floor F1 are allowed access on the network. In one implementation, all other wireless clients belonging to that user are unaffected by the user exiting. If the user exits the secured first floor F1, all wireless clients on the first floor are denied access to the network.

FIG. 8 illustrates another example of a secure first floor in a single building having multiple floors. As FIG. 8 shows, the building includes floors F1-F5 with a firewall 802 securing the first floor F1 and the second floor F2. In this example, the building deployment is such that the customer (e.g., user of the network) does not own or have control over all floors within the building. For example, the customer uses only the first floor F1 and the second floor F2. In one implementation, the customer may deploy entry/exit units (e.g., security badge reader) at doorways on the first floor F1 and second floor F2 as well as at the elevators on the first and second floors F1 and F2. As such, an entry/exit unit tracks when a given user enters and/or exits the first floor or second floor.

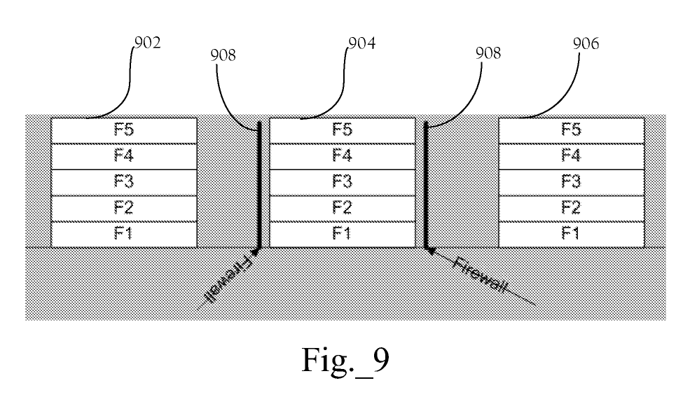

FIG. 9 illustrates example buildings 902, 904, and 906, one of which has all floors secured. As FIG. 9 shows, building 904 includes floors F1-F5 with a firewall 906 securing all of the floors F1-F5. In this scenario, the other buildings 902 and 906 are close enough to the secured building 904 to potentially gain access to its internal network.

In one implementation, in this example, central controller 42 may apply a global in/out policy to control network access. For example, if a user enters the secured building 904, all wireless clients of the user within this building (and all other buildings 902 and 906) will be typically allowed access on the network. If a user exits the secured building 904, all wireless clients of the user in the entire campus will be denied access to the network.

In one implementation, central controller 42 may apply a specific-perimeter in/out policy to control network access. For example, if a user enters secured building 904, all wireless clients within secured building 904 are allowed access on the network. In one implementation, all other wireless clients in other buildings belonging to that user are unaffected by the user exiting building 904. If the user exits secured building 904, all wireless clients of the user in secured building 904 is denied access to the network.

D.1. Example Application of a Global In/Out Policy

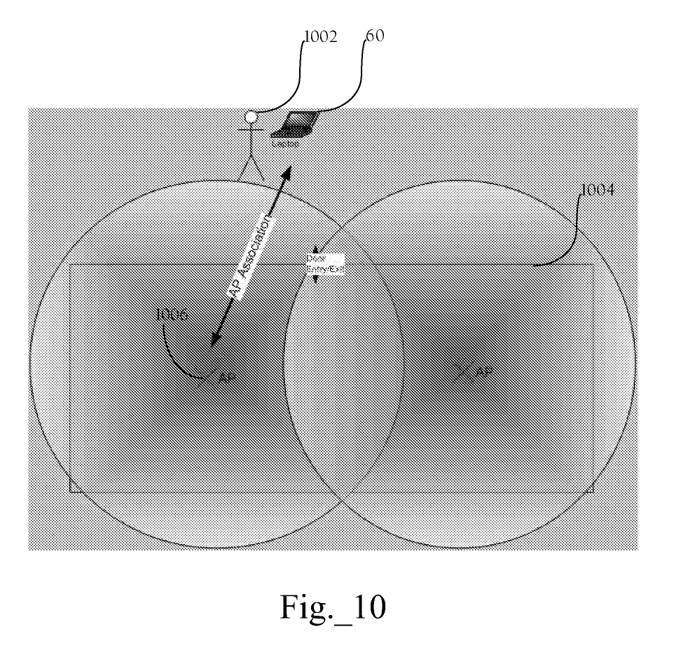

FIGS. 10, 11, 12, and 13 illustrate an example application of a global in/out policy to control access to the network applied to a user who enters and later exits a secured area (e.g., building) with one or more wireless clients (e.g., laptop, PDA, etc.) that are physically with the user.

FIG. 10 illustrates an example scenario where a user 1002 approaches a secured area 1004. As FIG. 10 shows, user 1002 is outside secured area 1004 (e.g., in the parking lot) and has one or more wireless devices 60. When the user 1002 associates with a wireless access point 1006 in secured area 1004, authentication server 21 performs AAA authentication to confirm that the user is a valid user with the correct credentials but does not yet complete the 802.1x handshake. Location server 22 checks if the user 1002 has physically entered secured area 1004 by looking at security badge entry records. If user 1002 has not entered secured area 1004, central controller 42 denies access by sending an 802.1x failure message to the user's device and will continue to deny access as long as the user 1002 remains outside secured area 1004.

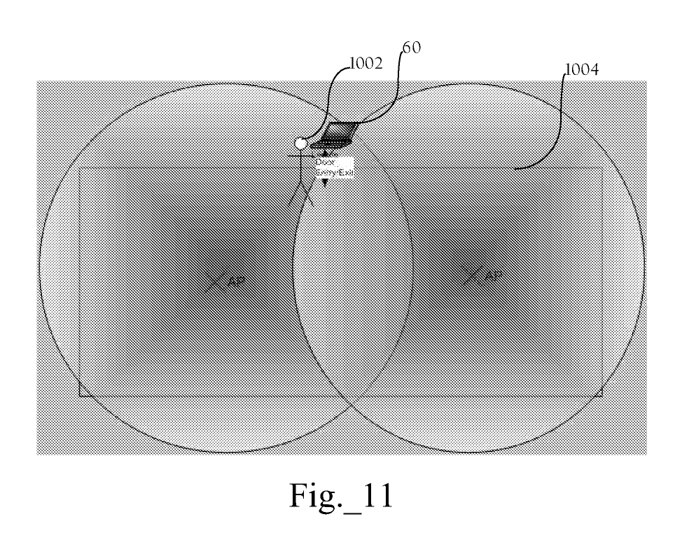

FIG. 11 illustrates an example scenario where user 1002 enters secured area 1004 using a security badge. In one implementation, when the user 1002 uses the security badge to enter secured area 1004, the entry/exit unit at the entry notifies central controller 42 that that particular user 1002 has entered that particular entry or doorway. Central controller 42 looks up the doorway, identifies the secured area 1004 and WLAN network associated with that secured area, and records that that particular user 1004 is within secured area 1004.

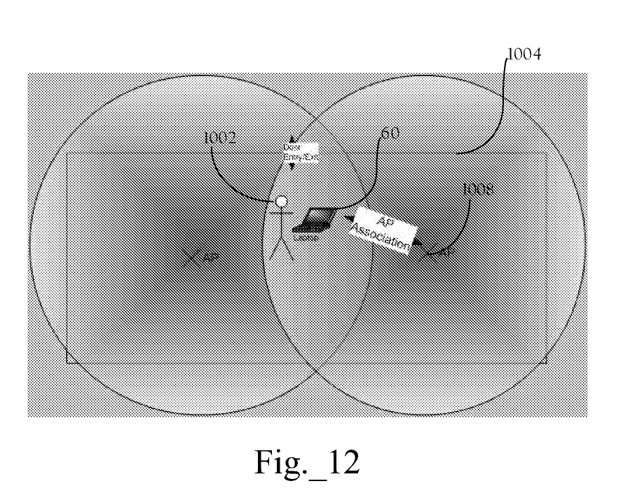

FIG. 12 illustrates an example scenario where a wireless client 60 of user 1002 is associated with a wireless access point 1008 within secured area 1004. The wireless client 60 is associated after the authentication server 21 has successfully authenticated user 1002 as having correct credentials and after location server 22 has determined that user 1004 has physically entered secured area 1004. Central controller 42 grants access by sending an 802.1x success message to the wireless client 60 of user 1002. In one implementation, these steps are repeated for each wireless client that the user 1002 wants to associate to the network.

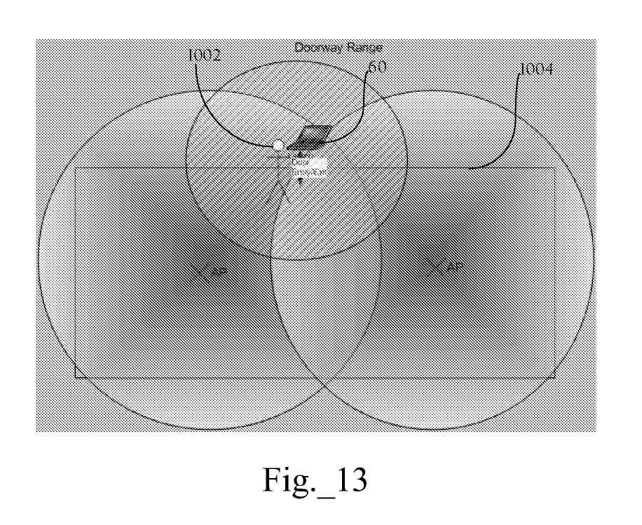

FIG. 13 illustrates an example scenario where user 1002 exits secured area 1004 using a security badge. In one implementation, the entry/exit unit at the doorway through which user 1002 exits notifies central controller 42 that user 1002 has exited the particular doorway. Central controller 42 looks up that particular doorway, identifies the secured area 1004 and associated WLAN network, and records that user 1002 has left secured area 1004. In one implementation, central controller 42 detects and de-authenticates/dis-associates all wireless clients belonging to user 1002.

In one implementation, as long as user 1002 is outside secured area 1004 (e.g., in the parking lot), the wireless clients 60 of user 1002 will remain unauthenticated and central controller 42 will continue to deny network access.

D.2. Second Example Application of a Global In/Out Policy

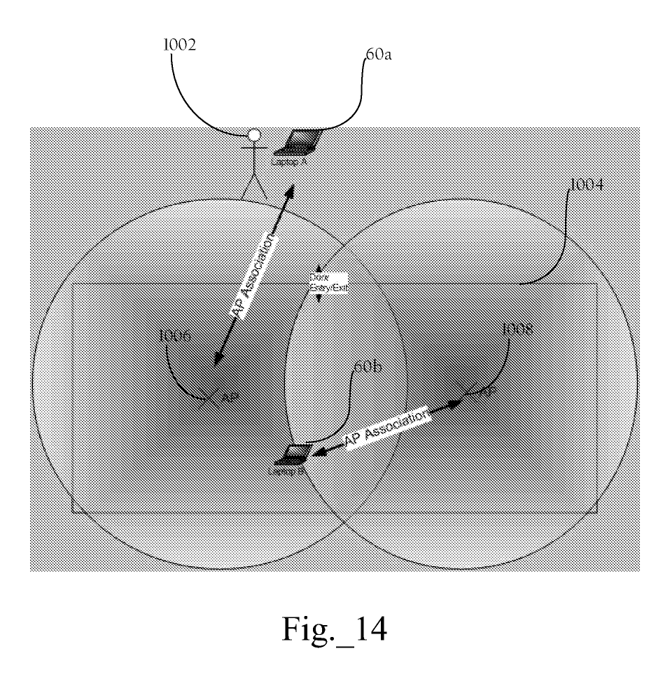

FIGS. 14, 15, and 16 illustrate an example application of a global in/out policy applied to a user who enters and later exits a secured area, where one or more wireless clients that are physically with the user and one or more wireless clients are not physically with the user but are instead in the secured area.

FIG. 14 illustrates an example scenario where a user 1002 has one or more wireless clients 60a physically with user 1002 and associated with a wireless access point 1006 as user 1002 approaches secured area 1004. User 1002 also has one or more wireless clients 60b already in secured area 1004 and associated with wireless access point 1008.

When wireless clients 60a and 60b both associate and attempt authentication, authentication server 21 performs AAA authentication to ensure that user 1002 is a valid user with the correct credentials. In one implementation, authentication server 21 does not complete the 802.1x handshake for either wireless client 60a and 60b until after location server 22 ensures that user 1002 has physically entered secured area 1004. In one implementation, before user 1002 has physically entered secured area 1004, central controller 42 denies network access by sending 802.1x failure messages to each of the wireless clients 60a and 60b.

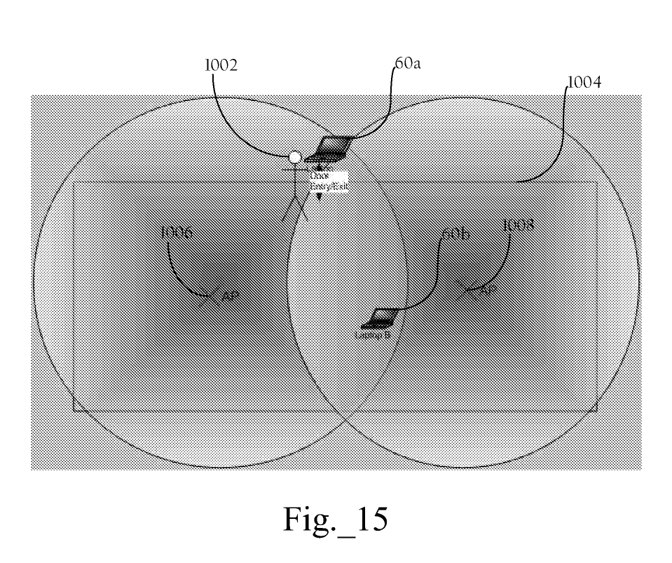

FIG. 15 illustrates an example scenario where user 1002 has physically entered secured area 1004 using a security badge. When user 1002 enters secured area 1004, an entry/exit unit at the doorway notifies central controller 42 that user 1002 has entered that particular doorway. Central controller 42 then looks up that doorway, identifies the associated secured area 1004 and associated WLAN network, and records that user 1002 is within secured area 1004.

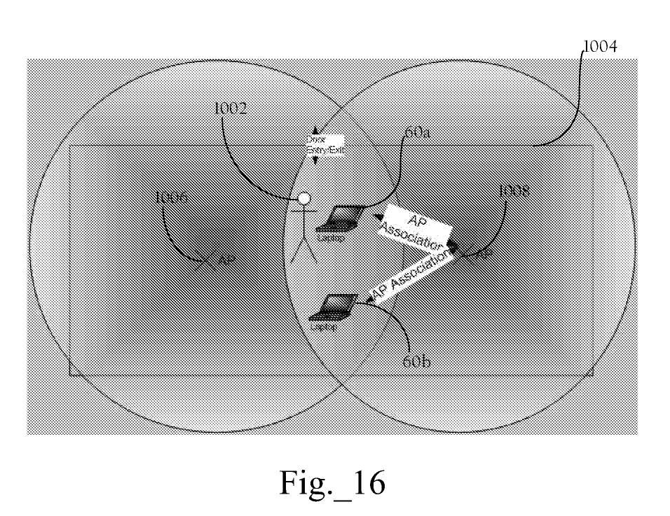

FIG. 16 illustrates an example scenario where wireless clients 60a and 60b of user 1002 are associated with wireless access point 1008 within secured area 1004. Authentication server 21 performs AAA authentication to ensure that user 1002 is a valid user with the correct credentials.

Authentication server 21 does not yet complete the 802.1x handshake until after location server 22 confirms that user 1002 is physically within secured area 1004. Once user 1002 is physically within secured area 1004, central controller 42 grants access by sending 802.1x success messages to wireless clients 60a and 60b.

In one implementation, when user 1002 leaves secured area 1004 using a security badge (e.g., see user position in FIG. 15), the entry/exit unit at the doorway notifies central controller 42 that user 1002 has exited that doorway. Central controller 42 looks up that particular doorway, identifies the associated secured area 1004 and associated WLAN network, and records that user 1002 has left secured area 1004.

In one implementation, central controller 42 also detects all wireless clients belonging to user 1002. Central controller 42 de-authenticates/dis-associates each identified wireless access point 60a and 60b. In one implementation, as long as user 1002 remains outside secured area 1004, central controller 42 will continue to deny network access.

### E. Example Hardware System

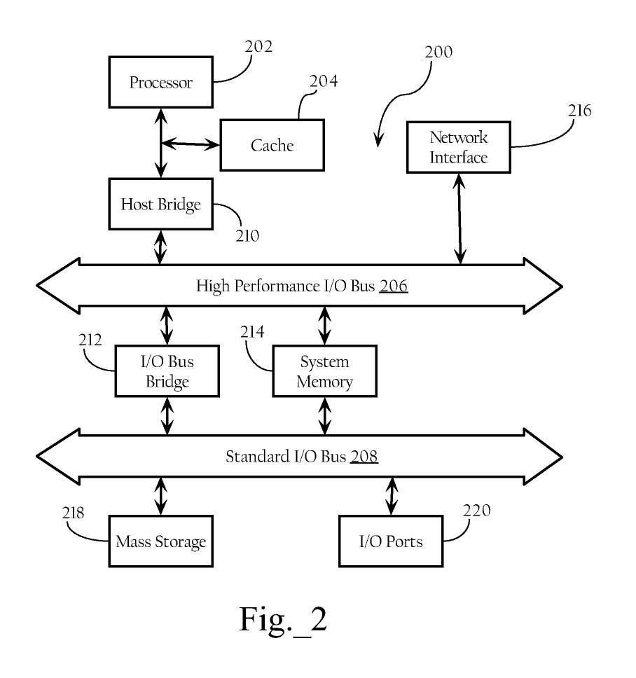

FIG. 2 illustrates an example hardware system 200, which may be used to host the physical gateway 20, the location server 21 and/or the authentication server 21. In one implementation, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218 and I/O ports 220 couple to bus 208. Hardware system 200 may optionally include a keyboard and pointing device (not shown) coupled to bus 208. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the system controller, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain implementations of the present invention may not require nor include all of the above components. For example, the peripheral devices shown coupled to standard I/O bus 208 may couple to high performance I/O bus 206. In addition, in some implementations only a single bus may exist, with the components of hardware system 200 being coupled to the single bus. Furthermore, hardware system 200 may include additional components, such as additional processors, storage devices, or memories.

As discussed above, in one embodiment, the operations of the WLAN management server 20 described herein are implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP/Vista operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

The present invention has been explained with reference to specific embodiments. For example, while embodiments of the present invention have been described as operating in connection with IEEE 802.11 networks, the present invention can be used in connection with any suitable wireless or wired network environment. For example, the functions disclosed above can be incorporated into an Ethernet switch that determines whether a given user has entered an area prior to allowing access. Other embodiments will be evident to those of ordinary skill in the art. It is therefore not intended that the present invention be limited, except as indicated by the appended claims.

What is claimed is:

1. A method comprising:
monitoring, responsive to a network access request of a client, an authentication session between an authentication server and the client;
determining user credential information associated with a user of the client based on one or more messages of the authentication session;
accessing, using the user credential information, physical entry information indicating a physical location of the user relative to a defined perimeter;
conditionally allowing the client access to a network based on the physical entry information and a successful authentication of the client.

2. The method of claim 1 wherein the determining comprises applying one or more access rules, wherein at least one of the one or more access rules permits access to the network based on the location of the client and the location of the user.

3. The method of claim 1 wherein the determining comprises applying one or more access rules, wherein at least one of the one or more access rules permits access to the network based on an identity of the user.

4. The method of claim 1 wherein the determining comprises applying one or more access rules, wherein at least one of the one or more access rules permits access to the network only if the client of the user is inside a predefined range of a wireless access point within the predefined secured area.

5. The method of claim 1 wherein the determining comprises applying one or more access rules, wherein at least one of the one or more access rules permits access to the network only if the user is inside the predefined secured area.

6. The method of claim 1 wherein the physical entry information comprises one or more ingress and egress points of the secured area.

7. The method of claim 1 further comprising terminating client access to the network if the user leaves the secured area.

8. The method of claim 1 further comprising determining a proximity of clients to a given user to ensure that multiple devices of the given user in different secured areas are not affected by the user entering or leaving a given secured area.

9. The method of claim 1 further comprising conditionally allowing the client access to the network before completing a successful authentication of the client.

10. Logic encoded in one or more tangible media for execution and when executed operable to:
monitor, responsive to a network access request of a client, an authentication session between an authentication server and the client;
determine user credential information associated with a user of the client based on one or more messages of the authentication session;
access, using the user credential information, physical entry information indicating a physical location of the user relative to a defined perimeter;
conditionally allow the client access to a network based on the physical entry information and a successful authentication of the client.

11. The logic of claim 10 wherein the logic is further operable to apply one or more access rules, wherein at least one of the one or more access rules permits access to the network based on the location of the client and the location of the user.

12. The logic of claim 10 wherein the logic is further operable to apply one or more access rules, wherein at least one of the one or more access rules permits access to the network only if the client of the user is inside a predefined range of a wireless access point within the predefined secured area.

13. The logic of claim 10 wherein the logic is further operable to apply one or more access rules, wherein at least one of the one or more access rules permits access to the network only if the user is inside the predefined secured area.

14. The logic of claim 10 wherein the physical entry information comprises one or more ingress and egress points of the secured area.

15. An apparatus comprising:
one or more processors;
a memory;
one or more network interfaces; and
logic encoded in one or more tangible media for execution and when executed operable to cause the one or more processors to:
monitor, responsive to a network access request of a client, an authentication session between an authentication server and the client;
determine user credential information associated with a user of the client based on one or more messages of the authentication session;
access, using the user credential information, physical entry information indicating a physical location of the user relative to a defined perimeter;
conditionally allow the client access to a network based on the physical entry information and a successful authentication of the client.

16. The apparatus of claim 15 wherein the logic is further operable to cause the one or more processors to apply one or more access rules, wherein at least one of the one or more access rules permits access to the network based on the location of the client and the location of the user.

17. The apparatus of claim 15 wherein the logic is further operable to cause the one or more processors to apply one or more access rules, wherein at least one of the one or more access rules permits access to the network only if the client of the user is inside a predefined range of a wireless access point within the predefined secured area.

18. The apparatus of claim 15 wherein the logic is further operable to cause the one or more processors to apply one or more access rules, wherein at least one of the one or more access rules permits access to the network only if the user is inside the predefined secured area.

19. The apparatus of claim 15 wherein the physical entry information comprises one or more ingress and egress points of the secured area.

20. The apparatus of claim 15 wherein the logic is further operable to cause the one or more processors to terminate client access to the network if the user leaves the secured area.
